(19) United States
(12) Patent Application Publication
(10) Pub. No.: US 2024/0246780 A1
(43) Pub. Date: Jul. 25, 2024

(54) RECEIVING DEVICE FOR TRANSPORTING OBJECTS BY MEANS OF A MOVER DESIGNED USING MAGNETIC LEVITATION TECHNOLOGY AND COMBINATION OF SUCH A RECEIVING DEVICE WITH AN UNLOADING DEVICE

(71) Applicant: SOMIC VERPACKUNGSMASCHINEN GMBH & CO. KG, Amerang (DE)

(72) Inventors: Christoph Koegel, Prutting (DE); Mathias Sickinger, Ampfing (DE); Bernhard Steffinger, Eiselfing (DE)

(21) Appl. No.: 18/421,134

(22) Filed: Jan. 24, 2024

(30) Foreign Application Priority Data
Jan. 24, 2023 (EP) 23153080.9

(51) Int. Cl. B65G 54/02; B65G 47/52

(52) U.S. Cl. CPC B65G 54/02; B65G 47/52

(57) ABSTRACT

The invention relates to a receiving device which is adapted to be connected to a mover not belonging to the receiving device and designed using magnetic levitation technology and intended for the transportation of at least one object also not belonging to the receiving device. The receiving device comprises a floor portion whose upper face is intended to support the at least one object during transportation. According to the invention, at least one recess is provided in the upper face of the floor portion, which leads into at least one side face of the floor portion. The invention further relates to a combination of such a receiving device with an unloading device.

### CROSS REFERENCE TO RELATED APPLICATION

This application claims priority to European Patent Application No. 23153080.9, filed in Europe on Jan. 24, 2023, the entire contents of which are hereby incorporated herein by this reference.

### DESCRIPTION

The invention relates to a receiving device which is adapted to be connected to a mover not belonging to the receiving device, designed using magnetic levitation technology and intended for the transportation of at least one object also not belonging to the receiving device, comprising a floor portion whose upper face is intended to support the at least one object during transportation.

From the applicant's PCT/EP2022/067894, it is known that a receptacle suitable for loading with at least one object can be attached to a mover of a device designed using magnetic levitation technology. However, PCT/EP2022/067894 does not specify how the at least one object can be removed from the receptacle.

US 2020/0030995 A1 generally describes a device designed using magnetic levitation technology.

The task of the invention is to provide a receiving device that can be unloaded in a simple manner

This task is solved by a receiving device of the type mentioned in the introduction, in which at least one recess is provided in the upper face of the floor portion which leads into at least one side face of the floor portion.

To unload the at least one object, an unloading portion of an unloading device not belonging to the receiving device, for example a tine of an unloading fork, can be inserted into this at least one recess so that it reaches under the at least one object without damaging the at least one object, in the best case even without touching the at least one object. After reaching underneath, the at least one object can then be lifted out of the receiving device by means of the unloading device.

As a consequence of reaching under the at least one object, the unloading device can always be inserted into the receiving device at the same height, regardless of the size and shape of the at least one object. Adaptation to different objects or different unloading heights can thus be avoided. This simplifies control of the unloading process.

Advantageously, a plurality of recesses can be provided. In this case, where more than two recesses are provided, the distance between any two adjacent recesses can preferably be the same.

In a further development of the invention, it is proposed that the at least one recess extends substantially rectilinearly, preferably running substantially orthogonally to the side face of the floor portion. This can simplify production. Furthermore, if there are a plurality of recesses, it is advantageous if at least two recesses run substantially parallel to each other.

Movers known from the prior art, in particular US 2020/0030995 A1, designed using magnetic levitation technology, can reach speeds of up to 3 m/sec and accelerations of up to 30 m/s². To be able to secure the at least one object during transportation, the receiving device can also have, in a manner known per se from PCT/EP2022/067894, a side wall portion which projects at least partially from the floor portion in the vertical direction on a side of the floor portion associated with the side face. Advantageously, such side wall portions can be provided on a plurality of the side faces, preferably all side wall portions of the floor portion.

To facilitate unloading of the receiving device, if the receiving device has at least one such side wall portion, this side wall portion can have at least one through hole which leads into the recess at the level of the floor portion and extends, preferably substantially rectilinearly, over the entire height of the side wall portion.

In the event that a plurality of recesses are provided, it is proposed that each through hole in the side wall portion leads into a recess.

Advantageously, an extent of the through hole in a horizontal direction, which extends substantially parallel to the side face, is at least as large as an extent of the at least one recess in the horizontal direction. For easier removal, it is also advantageous if the at least one recess leads into the through hole in such a way that it leads into the through hole across the full extent of its width. This allows a seamless transition between the at least one recess and the corresponding through hole.

For greater flexibility in the movement of the movers, it is proposed that the at least one recess leads into two side faces of the floor portion lying opposite one another with respect to the floor portion. This makes it possible to insert the at least one unloading portion of the unloading device into the recess from both of the side faces lying opposite one another. Furthermore, such a continuous recess makes it possible to reach fully underneath the at least one object, thus increasing the support stability of the at least one object. This can also prevent the at least one object from slipping when it is lifted out due to insufficient under-reach.

The flexibility of the receiving device and/or the movement of the movers can be further increased by the fact that at least one further recess is provided in the upper face of the floor portion, which leads into at least one further side face of the floor portion, with the at least one further recess and the at least one recess crossing each other. This allows the receiving device to be unloaded not only from the at least one side face, but also from the at least one further side face. In the case of a receiving device whose floor portion is square or rectangular, the at least one recess and the at least one further recess can be orthogonal to one another. The at least one further recess can have the same properties as those discussed above for the at least one recess. In particular, the at least one further recess can have substantially the same height and/or substantially the same width as the at least one recess.

It should be noted at this point that the at least one object in the receptacle can be transported in a lying or standing position. Where a plurality of objects are transported by the receiving device, these objects can be arranged in the form of one or more stacks, for example two or four stacks.

To facilitate the grouping of objects into a plurality of stacks, the receiving device may comprise at least one dividing wall projecting preferably orthogonally from the upper face of the floor portion. The at least one dividing wall can be arranged on the floor portion substantially parallel or substantially orthogonally to the at least one recess or substantially parallel or substantially orthogonally to the at least one further recess and/or have at least one through hole which is associated with the at least one recess and/or the at least one further recess.

To enable two or more receiving devices to be unloaded simultaneously, it is proposed that an through hole spacing between two through hole bisectors extending vertically of two adjacent through holes of the same side wall portion is greater than or equal to twice an edge spacing, said edge spacing being a distance between a vertically extending through hole bisector of an outermost through hole and an adjacent side wall edge portion. This allows two receiving devices to be arranged next to each other with little or no space between them. Although the through hole bisector is not a physical element of the receiving device, but only a theoretical auxiliary construct, it is advantageous to assume that it runs through the center of the width of the through hole in question.

In order to facilitate the insertion of the at least one unloading portion of the unloading device into the at least one recess, the at least one recess can have a lead-in chamfer at a mouth portion where it leads into the side face. The lead-in chamfer can be configured as a bevel, for example.

With a view to facilitating the loading of the receiving device, it is proposed in a further development of the invention that the thickness of the side wall increases going in a vertical direction down towards the floor portion. This means that the side wall portions can serve as a guide slope for the objects inserted into the receiving device.

To avoid undesirable interactions with the magnetic field of the magnetic levitation technology, the receiving device can be made of an electrically non-conductive and non-magnetizable material, preferably plastic, for example ABS plastic (acrylonitrile butadiene styrene).

According to a second aspect, the invention relates to a combination of the receiving device described above with an unloading device, wherein the unloading device comprises an unloading portion which is adapted to be inserted from the side face into the at least one recess and/or into the at least one further recess of the receiving device when the receiving device is in an unloading position, and to be led out of the at least one recess and/or the at least one further recess upwards out of the receiving device in the vertical direction. This means that the unloading portion can be inserted into the receiving device without coming into contact with the at least one object, thus reducing the risk of damage to the at least one object and also to the unloading portion. At this point it should be noted that the unloading portion moves vertically away from the at least one recess in the floor portion when moving upwards in the vertical direction, and in particular moves out of the at least one recess.

The at least one recess and/or the at least one further recess guides the unloading portion as it passes through the receiving device, so that the unloading portion can be inserted at a higher speed. Furthermore, the unloading portion can reach under a plurality of objects, in particular a plurality of stacked objects, and lift them out of the receiving device together. Therefore, in contrast to picking from above, whether by hand or by means of suction cups, at least one stack of objects, preferably all the objects held in the receiving device, can be unloaded from the receiving device by a single movement of the unloading portion, thus allowing the throughput rate to be increased.

The simple design of the combination of receiving device and unloading device avoids complex maintenance work, such as that required when using picking robots, and reduces the risk of malfunction. Moreover, the necessary investment can be kept low. The receiving device can be accurately guided to a predetermined unloading position by means of a mover connected to it.

The height of the floor portion can also be adjusted. This eliminates the control effort for the unloading device, which can therefore be of simpler overall design. Since the mover can already adjust the height as it moves into the unloading position, there is no need to adjust the height of the unloading device, which speeds up the unloading process. This allows the high speed of magnetic levitation technology to be fully utilized.

Furthermore, it is not necessary to adapt the unloading portions to the size and shape of the respective objects, thus further increasing the flexibility of the combination and further reducing costs. The unloading of receiving devices with different objects makes it easy to create a grouping for a downstream work step, for example a packaging work step.

At the start of the unloading process, a mover with the receiving device can move to a predetermined unloading position. In the unloading position, the unloading portion can be inserted into the at least one recess from the side face until it reaches a predetermined position. A stop can be provided for this purpose, for example. The unloading portion can then move upwards out of the at least one recess in the vertical direction, whereupon it engages with at least one object. By moving the unloading portion, the at least one object can be lifted out of the receiving device. After removing the at least one object from the receiving device, the unloading device can place the at least one object in a transfer position. Advantageously, the transfer position is arranged vertically above the upper edge of a side wall of the receiving device.

In a further development of the combination, it is proposed that the unloading device further comprises a base portion from which the at least one unloading portion protrudes in the form of at least one unloading tine, each unloading tine being adapted to be inserted into the at least one recess and/or into the at least one further recess.

The width of the unloading portion, in particular the unloading tine, can preferably be less than or equal to the width of the at least one recess and/or the at least one further recess. In addition, the height of the unloading portion, in particular the unloading tine, can preferably be less than or equal to the height of the at least one recess and/or the at least one further recess.

In principle, it is conceivable that the unloading portion, in particular at least one of the plurality of unloading tines, has a smaller extent in the insertion direction than the at least one recess or the at least one further recess of the receiving device starting from the respective side face. Advantageously, however, the unloading portion, in particular at least one of the plurality of unloading tines, can have a length which is greater than or equal to a distance, preferably a greatest distance, between two opposing side faces of the receiving device. In this way, damage to the receiving device due to a collision with an unloading device can be avoided, as the unloading device, in particular at least one of the plurality of unloading tines, can protrude through the recess. If the greatest distance between opposing side faces is less than or equal to the length of the unloading portion, the receiving device can be unloaded with the unloading device from any side face, provided that at least one recess or at least one further recess leads into it.

Furthermore, at a first inserted end of the unloading portion, an end stop can be provided which has a width that is less than or equal to the width of the at least one recess and/or the at least one further recess.

The flexibility of the arrangement of the receiving device and the unloading device for the unloading operation can be increased if a plurality of recesses are provided in the upper face of the floor portion of the receiving device, wherein a recess spacing between a recess bisector of a recess and each recess bisector of an adjacent recess is the same, and a tine spacing from a tine bisector of an unloading tine to each tine bisector of an adjacent unloading tine is the same. These uniform recess spacings and tine spacings mean that the unloading portion can be inserted into different recesses without the need for special adjustments.

In addition, a plurality of further recesses can be provided, wherein a further recess spacing between a further recess bisector of a further recess and each further recess bisector of an adjacent further recess can be the same.

The insertion of the unloading portion into the at least one recess or the at least one further recess can be further facilitated if the tine spacing is substantially an integer multiple of the recess spacing. Thus, the distribution pattern of the plurality of unloading tines corresponds to the distribution pattern of the at least one recess or the at least one further recess and thus also to the distribution pattern of the through holes, provided that the receiving device has a side wall portion which projects vertically from the floor portion on a side of the floor portion associated with the side face. Preferably, all unloading tines and all recesses and/or all further recesses are arranged with the same tine spacing and recess spacing and/or further recess spacing. To avoid damage to the receiving device and/or the unloading unit, it is proposed that the through hole of the receiving device has a width that is greater than the width of at least one tine of the unloading device.

The combination of receiving device and unloading device according to the invention allows the unloading process to be carried out more quickly because, unlike conventional unloading from above, there are no dead periods in which the receiving device is already in an unloading position but the unloading unit still has to be brought into an unloading position. For this reason alone, the device according to the invention has a higher throughput rate. The throughput rate can be further increased by the unloading portion having a width that is at least equal to an integer multiple of a recess spacing between two adjacent recesses. This means that several, preferably two, receiving devices can be unloaded simultaneously. The number of tines can be equal to the number of recesses of at least two receiving devices. With the maximum number of receiving devices to be unloaded, the distance between the two recesses which are each arranged adjacent to the outer ends of the outer receiving devices facing away from each other can be substantially equal to the distance between the outermost unloading tines. A predetermined gap can be provided between two adjacent receiving devices in the unloading position, so that the width of the unloading portion can be extended by the width of the predetermined gap. Where a plurality of receiving devices with different objects are unloaded at the same time, this can simplify the creation of a subsequent grouping for the next operation.

The invention is explained in more detail below based on exemplary embodiments with reference to the accompanying drawings. These show the following:

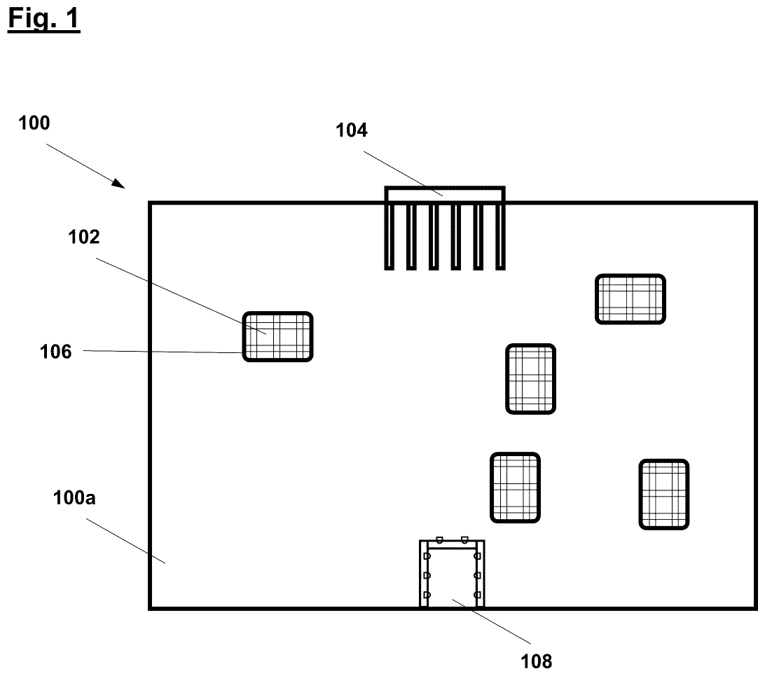

FIG. 1 A schematic plan view of a system for transporting objects using magnetic levitation technology;

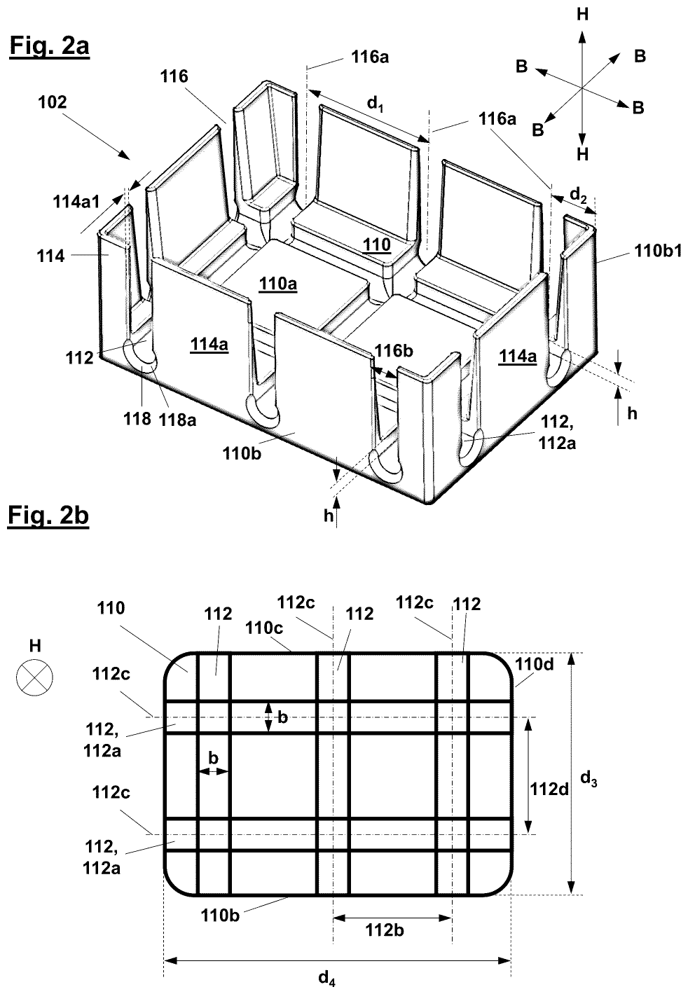

FIG. 2a A perspective view of a receiving device according to the invention, as can be used in the system of FIG. 1;

FIG. 2b A schematic plan view of the receiving device according to the invention of FIG. 2a;

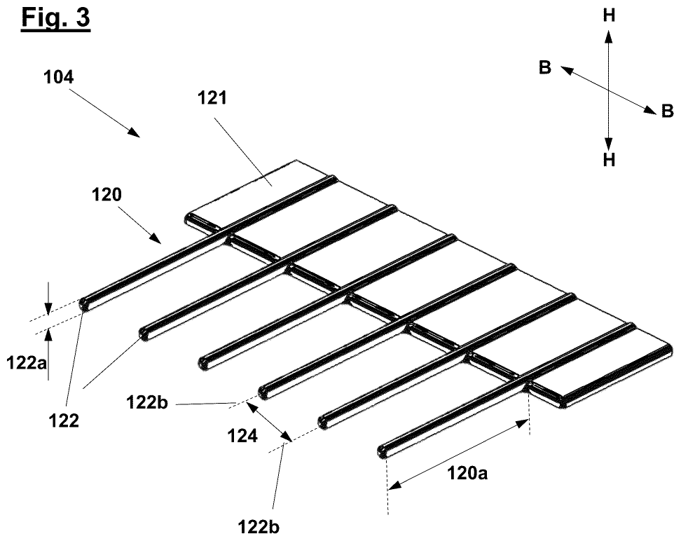

FIG. 3 A schematic representation of an unloading device according to the invention; and

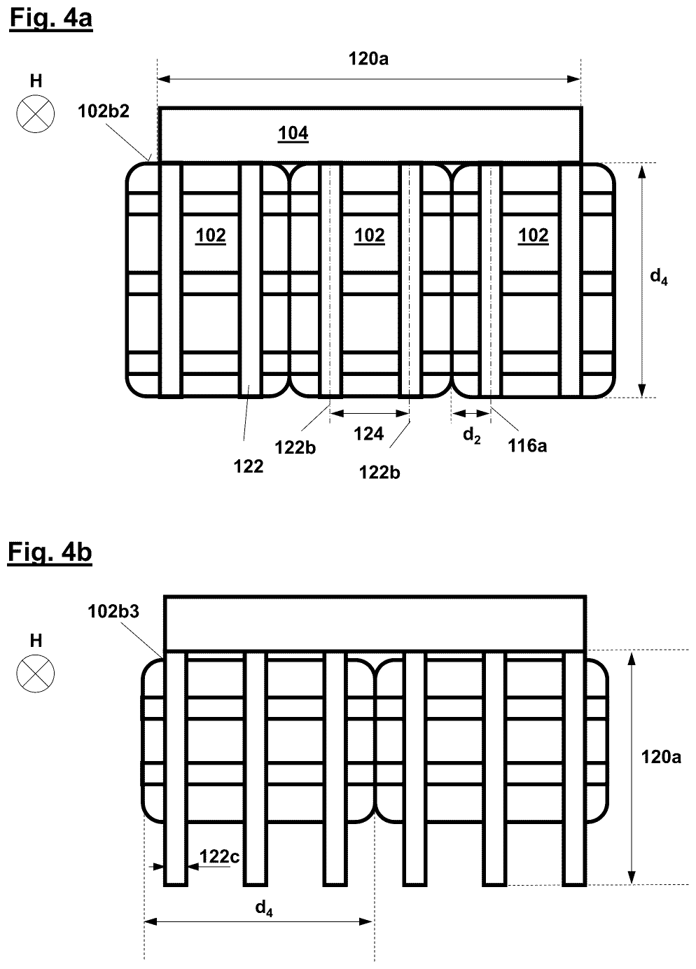

FIGS. 4a and b Plan views of a combination of the unloading portion of FIG. 3 and receiving devices according to FIG. 2a in different unloading arrangements.

In FIG. 1, a system designed using magnetic levitation technology is generally designated with the reference sign 100. The system 100 usually comprises a plurality of movers 106, each equipped with a receiving device 102 according to the invention, and an unloading device 104. The movers 106 can move on a movement area 100a of the system 100 using magnetic levitation technology. To load the receiving device 102 with at least one object (not shown) not belonging to the receiving device 102, a loading device 108, for example of conventional design, may also be provided.

As shown in FIG. 2a, the receiving device 102 comprises a floor portion 110 whose upper face 110a is intended to support the at least one object during transportation. At least one recess 112 is provided in the upper face 110a of the floor portion 110, which leads into at least one side face 110b of the floor portion 110. The at least one recess 112 extends substantially rectilinearly and runs substantially orthogonally to the side face 110b of the floor portion 110.

Furthermore, the receiving device 102 has a side wall 114 which projects from the floor portion 110 substantially orthogonally in the vertical direction H. In particular, the receiving device 102 has a side wall portion 114a which projects from the floor portion 110 in the vertical direction H on a side of the floor portion 110 associated with the side face 110b. This side wall portion 114a has a through hole 116 which leads into the at least one recess 112 at a mouth portion 118.

In the illustrated exemplary embodiment, a plurality of recesses 112 is provided in the upper face 110a of the floor portion. At least two of the recesses 112, preferably all of the recesses 112, are arranged substantially parallel to one another. Each of the recesses 112 leads into a through hole 116.

The at least one recess 112 leads into two side faces 110b and 110c (see FIG. 2b) of the floor portion 110 lying opposite one another with respect to the floor portion 110. In other words, the at least one recess 112 extends from the one side face 110b to the other side face 110c.

The at least one through hole 116 extends substantially rectilinearly over the entire height of the associated side wall portion 114a. In the mouth portion 118, the recess 112 and the through hole 116 into which the recess 112 leads have a substantially equal extent in a horizontal direction B.

According to the present exemplary embodiment, each of the side faces 110b and 110c (see FIG. 2b) lying opposite one another with respect to the floor portion 110 has a side wall portion 114a projecting in the vertical direction H with an associated through hole 116, with the through hole 116 leading into the at least one recess 112.

To increase the flexibility of the receiving device 102, at least one further recess 112a is provided in the upper face 100a of the floor portion 110, which leads into at least one further side face 110d of the floor portion 110. The at least one recess 112 and the at least one further recess 112a cross each other and extend substantially orthogonally to each other.

At this point it should be noted that the at least one further recess 112a advantageously has the same properties as the at least one recess 112, so that reference can be made to the description thereof in order to avoid repetition. For example, the at least one further recess 112a leads into a through hole 116 of a side wall portion 114a. Furthermore, the at least one further recess 112a can have substantially the same height h and substantially the same width b as the at least one recess 112.

A through hole spacing di between two through hole bisectors 116a extending in the vertical direction H (shown as dotted lines) of two adjacent through holes 116 of the same side wall portion 114a is greater than, preferably more than twice as large as, an edge spacing d₂. Edge distance d₂ refers to a distance between a through hole bisector 116a and an adjacent side face edge portion 110b1.

To facilitate entry of the unloading device 104 into the at least one recess 112 and/or the at least one further recess 112a, at least one recess 112 and/or at least one further recess 112a has a lead-in chamfer 118a at the mouth portion 118.

Since the risk of collision between the receiving device 102 and the unloading device 104 is greatest at the mouth portion 118, the side wall portion 114a may have a thickness 114a1 that is greatest at the floor portion 110. The thickness 114a1 of the side wall portion 114a can decrease in the vertical direction H. As a result, the side wall portion 114a can also have a slight funnel shape, which makes it easier to load the receiving device 102 with objects.

It should be noted that, in the exemplary embodiment shown in FIGS. 2a and 2b, the receiving device 102 comprises three recesses 112 and two further recesses 112a.

An unloading device 104 according to the invention is shown schematically in FIG. 3. This unloading device 104 comprises an unloading portion 120 which is adapted to be inserted from the side face 110b of the floor portion 110 into at least one recess 112 or into at least one further recess 112a of the receiving device 102, and a base portion 121. Furthermore, the unloading device 104 is adapted to move the unloading potion 120 in the vertical direction H by means of a lifting device not shown.

In the exemplary embodiment shown in FIG. 3, the unloading portion 120 comprises a plurality of (here six) unloading tines 122 projecting from the base portion 121. Each of the tines 122 is adapted to enter a recess 112 or a further recess 112a. For this purpose, the unloading portion 120, namely each tine 122, has a height 122a which may be less than or equal to an extent of the at least one recess 112 or the at least one further recess 112a in the vertical direction H, namely the height h.

FIGS. 4a and 4b show a plan view of a combination of the unloading device 104 with a plurality of receiving devices 102. Whereas in FIG. 4a the unloading portion 120 interacts with a total of three receiving devices 102 from their shorter side face 110b2, in FIG. 4b the unloading portion 120 interacts with two receiving devices 102 from their longer side face 102b3.

The unloading portion 120 has a length 120a that is greater than or equal to a length d₄ of the floor portion 110 of the receiving device 102.

As previously mentioned, a plurality of recesses 112, 112a is provided, the recess spacing 112b of the recess bisectors 112c (shown as a dotted line in FIG. 2b) of two adjacent recesses 112, 112a being the same in each case. In other words, both the recesses 122 and the further recesses 122a are equally distributed in the floor portion 110.

The same applies to a tine spacing 124 of the tine bisectors 122b (shown as a dotted line in FIG. 4a) between two adjacent tines 122, the tine spacing 124 preferably being an integer multiple of the recess spacing 112b.

1. A receiving device adapted to be connected to a mover not belonging to the receiving device and designed using magnetic levitation technology and intended for transportation of at least one object also not belonging to the receiving device, the receiving device comprising:
a floor portion having at least one side face and an upper face, wherein the upper face is configured to support the at least one object during transportation; and
at least one recess provided in the upper face of the floor portion, wherein said at least one recess leads into the at least one side face of the floor portion.

2. The receiving device of claim 1, wherein the at least one recess extends substantially rectilinearly, running substantially orthogonally to the side face of the floor portion.

3. The receiving device of claim 1, wherein the receiving device has at least one side wall portion which projects at least partially from the floor portion in a vertical direction on a side of the floor portion associated with the side face,
wherein the at least one side wall portion has at least one through hole which leads into the at least one recess, and
wherein the at least one recess is at the level of the floor portion.

4. The receiving device of claim 1, wherein the at least one recess leads into two side faces of the floor portion lying opposite one another with respect to the floor portion.

5. The receiving device of claim 1, wherein at least one further recess is provided in the upper face of the floor portion, which recess leads into at least one further side face of the floor portion, with the at least one further recess and the at least one recess crossing each other.

6. The receiving device of claim 3, wherein, a through hole spacing between two through hole bisectors extending in the vertical direction of two adjacent through holes of a side wall portion is greater than or equal to twice an edge spacing, the edge spacing being a distance between a through hole bisector of an edge through hole extending in the vertical direction and an adjacent side face edge portion.

7. The receiving device of claim 3, wherein the at least one recess comprises a lead-in chamfer at a mouth portion where the at least one recess leads into the side face.

8. The receiving device of claim 3, wherein the side wall portion has a thickness which increases going in the vertical direction down towards the floor portion.

9. The receiving device of claim 1, wherein the at least one recess is configured to receive at least one unloading portion of an unloading device via the side face when the receiving device is in an unloading position, and to allow the at least one unloading portion to be raised upward in a vertical direction out of the receiving device when the receiving device us in the unloading position.

10. The receiving device of claim 9, wherein the unloading device further comprises a base portion from which the at least one unloading portion protrudes in the form of at least one unloading tine, and wherein the at least one recess is adapted to receive the at least one unloading tine.

11. The receiving device of claim 9, wherein the at least one recess has a height greater than or equal to a height of each unloading tine.

12. The receiving device of claim 9, wherein the at least one recess has a length that is less than or equal to a length of each unloading tine.

13. The receiving device of claim 9, wherein a plurality of recesses is provided in the upper face of the floor portion of the receiving device, wherein a recess spacing between a recess bisector of a recess and each recess bisector of each adjacent recess is the same.

14. The receiving device of claim 13, wherein the recess spacing is such that a spacing between the one or more unloading tines is substantially an integer multiple of the recess spacing.

15. The receiving device of claim 13, wherein the recess spacing is such that a width of the unloading portion of the unloading device is at least equal to an integer multiple of the recess spacing.

16. The receiving device of claim 3, wherein the at least one through hole extends substantially rectilinearly over an entire height of the side wall portion.

17. The receiving device of claim 9, wherein the at least one recess has a length equal to a distance between two opposing side faces of the floor portion of the receiving device, wherein such length is less than or equal to the length of the at least one unloading tine.

18. A system comprising:
a receiving device adapted to be connected to a mover not belonging to the receiving device, wherein said mover is intended for transportation of at least one object also not belonging to the receiving device, the receiving device comprising:
a floor portion having at least one side face and an upper face, wherein the upper face is configured to support the at least one object during transportation,
at least one recess provided in the upper face of the floor portion, wherein said at least one recess leads into the at least one side face of the floor portion; and
an unloading device comprising at least one unloading portion which is adapted to be inserted from the side face into the at least one recess of the receiving device when the receiving device is in an unloading position, and to be led out of the at least one recess upwards out of the receiving device in the vertical direction.

19. The system of claim 18, wherein the unloading device further comprises a base portion from which the at least one unloading portion protrudes in the form of at least one unloading tine, each unloading tine being adapted to be inserted into the at least one recess.

20. The system of claim 19, wherein each unloading tine has a height which is less than or equal to a height of the at least one recess.
